(19) United States
(12) Patent Application Publication
(10) Pub. No.: US 2005/0163061 A1
(43) Pub. Date: Jul. 28, 2005

(54) Zero configuration peer discovery in a grid computing environment

(75) Inventors: Benjamin F. Piercey, Richmond (CA); Marc Andre Vachon, Ottawa (CA); Ian Van Gough, Ottawa (CA); William Gerald Love, Ottawa (CA); Aaron Charles Brown, Ottawa (CA)

Correspondence Address: BORDEN LADNER GERVAIS LLP, WORLD EXCHANGE PLAZA, 100 QUEEN STREET SUITE 1100, OTTAWA, ON, K1P 1J9, CA

(73) Assignee: GRIDIRON SOFTWARE, INC.

(21) Appl. No.: 11/044,017

(22) Filed: Jan. 28, 2005

Related U.S. Application Data
(60) Provisional application No. 60/539,350, filed on Jan. 28, 2004.

(51) Int. Cl. H04L 12/42; H04L 12/28

(52) U.S. Cl. 370/255; 370/449

(57) ABSTRACT

A peer to peer discovery mechanism based on the ubiquitous TCP/IP and UDP/IP standards requires no global network configuration to allow the addition and removal of peers from the network. The resulting network architecture is scalable to a large number of processors and together with an automated Peer Voting mechanism which elects a “Prime” Peer at runtime provides a platform for use with distributed computing applications.

### CROSS-REFERENCE TO RELATED APPLICATIONS

This application claims the benefit of U.S. Application No. 60/539,350, filed Jan. 28, 2004, the contents of which are expressly incorporated herein by reference.

### FIELD OF THE INVENTION

The present invention relates generally to peer discovery in a peer-to-peer network. More particularly, the present invention relates to discovery of peers for a grid or cluster-based computing network.

### BACKGROUND OF THE INVENTION

Many software applications require the combined resources of a number of computers, which are connected together through standard and well-known networking techniques, such as TCP/IP networking software running on the computers and on the hubs, routers, and gateways that interconnect the computers. In particular, grid or cluster-based computing makes use of a network of interconnected computers to provide additional computing resources necessary to solve complex problems.

Many grid or cluster-based computing networks rely upon a peer-to-peer (p2p) configuration. In such a p2p network, each node must know how to locate every other node participating in the network. This can be done by statically provisioning each node. However, a statically defined network is incapable of accepting new participants without requiring the re-configuration of existing nodes. The reconfiguration of nodes to accept new participants and delete unavailable participants is a time consuming process, but without such reconfiguration, a static network is incapable of using all the available resources. For these reasons, adaptive peer-to-peer networks with dynamic discovery of peers are considered preferable.

Unfortunately, adaptive configuration of a grid or cluster using existing TCP/IP software is often complex. Technologies such as AppleTalk™ and Rendezvous™ by Apple Computer, Inc. attempt to solve the complexity problem, but introduce new problems. AppleTalk devices can not communicate with the far more common TCP/IP connected Ethernet devices in use today. Rendezvous is based on TCP/IP, but scalability and efficiency problems remain.

Other peer-to-peer networks rely upon a node joining the network knowing, a priori, at least one other node in the network. From the connection to one node in the network, connections to other nodes can be formed, and contact with all nodes in the network can be achieved by relying upon connected nodes to pass messages to all other nodes that they are connected to. By assigning each message a time-to-live value based on the number of hops, a high statistical probability of distributing a message through the entire network can be achieved. Networks of this variety are ad hoc in nature and, though they benefit from a planned structure, typically generate higher levels of network traffic as each node in the network continually passes messages. At any given node, a message is usually received from more than one connected node, which generates large volumes of unnecessary traffic. Peer-to-peer networks having this configuration are considered inefficient, largely because no one node on the network maintains a list of all other network nodes.

It is, therefore, desirable to provide a peer-to-peer discovery protocol that is adaptive, efficient and easily scalable.

### SUMMARY OF THE INVENTION

It is an object of the present invention to obviate or mitigate at least one disadvantage of previous peer discovery methods and mechanisms.

In a first aspect of the present invention, there is provided a peer discovery method for determining a prime in a peer-to-peer network having at least one system. The method comprises transmitting a voting message including a voting token; initializing a timer; listening on a predetermined port for voting tokens transmitted by another system in the network; and entering a prime mode upon expiry of the timer if no superior voting token is received.

In embodiments of the first aspect of the present invention, the method can include the further step of entering a vanilla peer mode when a superior voting token is received. In another embodiment, the step of transmitting a voting message includes transmitting a voting token containing a voting number entering a prime mode upon determining that no received voting token has a higher voting number. In another embodiment, the step of transmitting includes multicasting the voting token to all nodes on a subnet. In a further embodiment, the step of entering a prime mode includes transmitting an assertion of prime status to all nodes from whom a voting token is received, and creating a list of all nodes from whom a voting token is received. In another embodiment, the step of entering a vanilla peer mode upon receipt of an assertion of prime status from another node. In a further embodiment, the step of listening includes listening for tokens associated with a grid identifier associated with the node. The yet a further embodiment, the method includes the step of requesting an update from all peers from whom a voting token has been received upon entering the prime mode.

In a second aspect of the present invention, there is provided a system for carrying out the methods of the present invention.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is an illustration of an exemplary network stack for a system of the present invention;

FIG. 2 is a state machine of the present invention;

FIG. 3 is a flow chart illustrating a method of the present invention;

FIG. 4 is a flow chart illustrating a method of the present invention;

FIG. 5 is a flow chart illustrating a method of the present invention; and

FIG. 6 is a block diagram illustrating data flows of the present invention.

### DETAILED DESCRIPTION

The architecture of the present invention allows the computers in the p2p network to discover each other and automatically set up a processing network, distribute work, and recover from failure. After installation of the peer, no administration, configuration or ongoing management is necessary. Generally, the present invention provides a method and system for peer discovery in a peer-to-peer (p2p) network. The p2p discovery mechanisms are preferably based on the ubiquitous TCP/IP and UDP/IP standards, but can use other networking protocols without departing from the scope of the present invention. Furthermore, the mechanisms preferably require no global network configuration to add or remove peers from the network. The solution is preferably scalable to a large number of processors through careful combination of both multicast and connection-based messaging, together with an automated peer voting mechanism which elects a “prime” peer at runtime. The Prime peer is preferably responsible for providing a list of available peers whenever a new p2p network-enabled application is launched. The mechanisms are preferably: robust to failures of an individual machine, through detection of peer failure, routing around failed peers, and if necessary, repetition of the peer voting algorithm.

The peer-to-peer network described herein makes use of a series of peers. To allow discovery of peers, each peer has a mechanism for allowing it to announce to the other peers that it is present. One of the peers is selected as a prime. The designated prime stores a list of peers in the network. When a peer in the network needs a listing of other peers, a request can be generated and send to the prime. Thus, each non-prime peer, also referred to as a vanilla peer, need only store the address of the prime in the network, while the prime stores a listing of all peers. Nodes remain on the prime's node list until they have been found to be dead. If the prime attempts to contact a node that is on the list but is. inactive, the prime can determine the node to be dead and then remove the node from the network. If a vanilla peer requests a listing of nodes, and attempts to contact nodes on the network that are inactive, the inactivity of a node can be reported to the prime for removal from the peer list. In a presently preferred embodiment, any peer in the network can become the prime node.

To allow for redundancy, a backup prime can be designated when the network is created, so that if the prime fails, the backup prime can assume the responsibilities of the prime. In an alternate embodiment, a mechanism to select a new prime can be implemented so select a new prime upon the failure of the prime.

In the p2p network described herein, it is preferable that all nodes know how to locate every other node participating in the network. A peer service discovery (PSD) protocol provides a mechanism by which peers in a network can dynamically discover each other. This protocol preferably provides each peer in the network with access to a list of all other known peers. Active connections need not be maintained between all peers using this protocol, as each peer can access the peer listing. Table 1 provides a list of the terminology used throughout.

TABLE 1

| | |
|---|---|
| Peer | An instance of a “Vanilla Peer” daemon running a |
| | machine in a network. |
| Vanilla Peer (VP) | A daemon that is capable of running a parallel |
| | application. Can be instructed to download its work. |
| Node | A machine in the network. A machine running as a |
| | VP in the network |
| Prime (P′) | A distinguished peer that is responsible for |
| | performing a network service. |
| Backup (Backup | A distinguished peer that is responsible for taking over |
| Prime, P″) | as Prime should the Prime fail. |
| Service | A specific area of distributed functionality. (e.g. peer |
| | end-pointing, check-pointing, etc . . . ) |

The PSD protocol of the present invention is preferably positioned on top of the transport layer (e.g. TCP or UDP) in the session layer. The PSD implementation involves the use of vanilla peers (VPs) on each node participating in the p2p network. VPs preferably run as daemons and are the participants in the PSD protocol. VPs also preferably serve as the execution environment for parallel applications that have been assigned to them.

Peers in the network can assume roles for controlling a given service. The roles include both the Prime and Backup Prime as described in the above table. Primes are responsible for management of data associated with a service. Backup Primes take over the role of Prime if P′ goes down, or may have some control functions delegated to them by the Prime. In each p2p network there can be an arbitrary number of backups.

Services are specific areas of distributed functionality. For instance, the task of determining all of the peers (end-points) in the network is an example of a service. Similarly, the task of determining the availability of any given node to do work is another service. The following tasks, some of which maybe distributed, can be included in a PSD protocol of the present invention: End-point Discovery; Peer Availability; Data Check-pointing; Load Balancing; Results Collection; and Operations, Administration, and Maintenance (OAM).

Prior to a discussion of a messaging protocol, a brief description of how the network is dynamically formed will be presented. When a peer is initialized, a prior configuration preferably determines a network port over which all communications are sent. The peer then transmits, using the configured port, a message to all nodes on the same subnet. This first message is considered as a voting message. After transmitting the voting message the peer listens for a reply. If there is already a network, then the network peers disregard the message, and the network prime records the address of the new peer, and asserts ownership of the prime status. If other peers are initializing at the same time, each peer with transmit a voting message. Each peer will receive the voting message transmitted by the other peers. If a received voting message is deemed to be stronger than the transmitted voting message, the peer enters its vanilla peer mode and records the address of the prime. Until a stronger voting message is received, the peer creates a list of the peers that it has received messages from. Based on the value of the voting message, a peer is selected to be the prime, and will have a list of all peers in the network. If, at a later time, another peer joins the network, it will transmit a voting message. In response, the prime will assert its ownership of the prime status and add the new peer to the peer list. If, at some time, the prime is unreachable, another node in the network can multicast a reset message to restart the voting process. In an alternate embodiment, each peer records the address of both the prime and a backup prime, based on the strength of the voting message, and if the prime fails, the backup prime continues in its place.

The PSD protocol uses both multicast and point-to-point messaging. In a presently preferred embodiment, the PSD protocol uses five messages: Vote; AssertPrime; PeerUpdate; complete and Reset. Note that the use of XML-style constructs in the following description is for illustrative purposes only; no part of the present invention is dependant on the use of XML as the PSD transport protocol.

The Vote message is preferably a multicast message, where each VP provides its VP token to the other VPs in the network. Each. VP token has at least one attribute that permits it to be compared and ranked against other VP tokens. For purposes of illustration, the tokens used in the following examples are numbers with a value attribute that can be compared. The Vote message is preferably multicast so that all nodes in the p2p network will receive the message. One skilled in the art will appreciate that the message is preferably sent to a port used exclusively for PSD, and may be used exclusively for the voting messaging. A node preferably sends the Vote message when it is first initialized (i.e. when it comes online). For example, a node engaged in discovering peers for a particular service can transmit: <vote service=“SERVICE” rand=“NUMBER”/>. One skilled in the art will appreciate that the random number can be replaced by a deterministic value, such as the system's media access control (MAC) address, or a number determined in accordance with a set of features particular to a computer. Deterministic values can also be combined with a random number. The use of weighted tokens permits nodes with particular properties to be given an advantage in the selection of Prime.

The AssertPrime message is preferably a multicast message where a single node on the network asserts to the other nodes in the p2p network that it is the Prime. The value of the token attribute, such as the numeric value of the random number, in the Vote message is used to resolve collisions between two or more VPs, each claiming to be the prime. For example, the message can be formatted as follows: <assertprime service=“SERVICE” rand=“NUMBER”/>.

The PeerUpdate message can be either multicast to the entire p2p network, or it can be unicast to a single node, such as the Prime P′. The PeerUpdate message preferably indicates the state of a VP for a given service. For end-pointing the available states include UP or DOWN, where for availability the states include both BUSY and IDLE. For example, the message can be formatted as follows: <peerupdate service=“SERVICE” state=“STATE”/>.

The Reset message is preferably a multicast message to all nodes in the p2p network, which is sent when an application attempts to establish a connection to a service Prime and fails. The node that detects the failure preferably transmits the message as a multicast to the other nodes in the network to notify the rest of the network that a node is down. This message preferably causes the other VPs to restart the election process for the role of service P′ to replace the unreachable node. For example, the message can be formatted as <reset service=“SERVICE”/>.

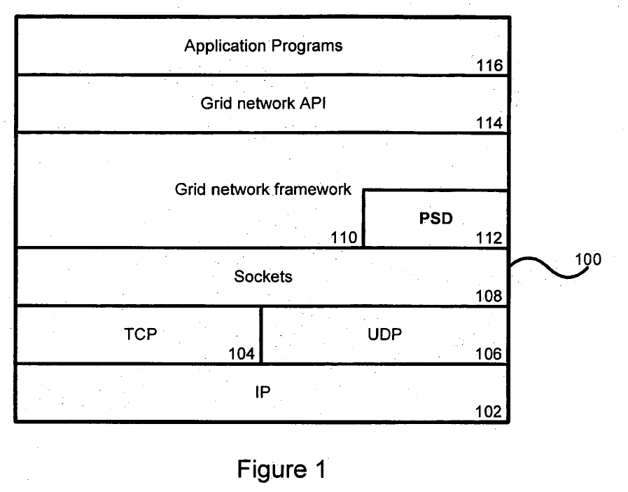

FIG. 1 illustrates a partial network stack 100 of a peer of the present invention. A network protocol 102, such as the Internet Protocol serves as a base and provides networking functionality to a transport layer preferably including both TCP 104 and UDP 106. A sockets layer 108 sits atop the transport layer and supports the grid network framework 110, which includes the peer service discovery 112. A grid networking application programming interface 114 and networked applications reside atop the framework 100.

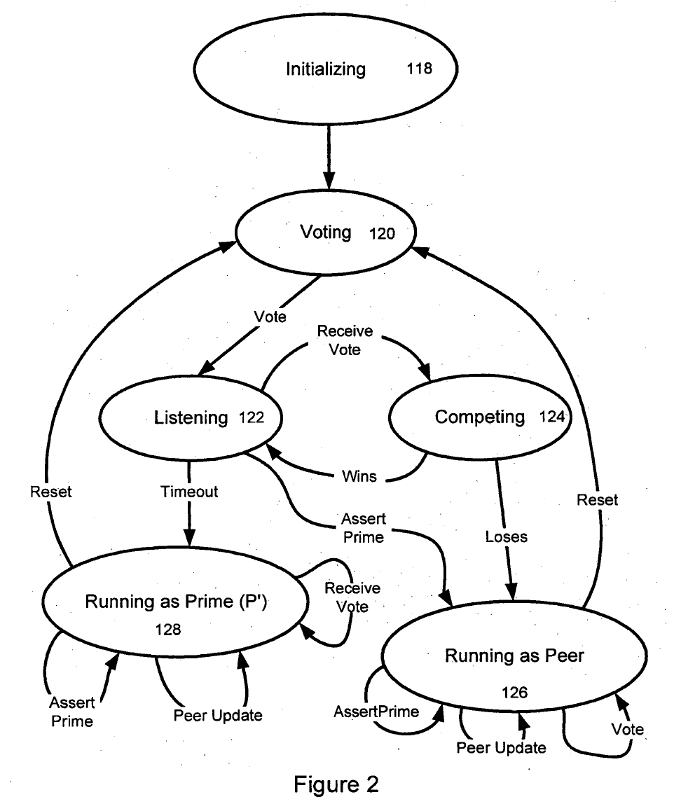

FIG. 2 shows the peer discovery method of the present invention for a VP joining the network by illustrating various states that a peer can assume, and the messages that move the peer from state to state. The peer starts in an Initializing State 100 where Random numbers, or other voting tokens, are generated, multicast sockets prepared and listening threads started. Upon completion of the determined initializing operations, the state machine proceeds to a Voting State 120. The voting state multicasts a voting message to other peers, and enters a listening state 122. In the listening state 122, the machine waits for receipt of voting messages from other peers. When a voting message is received, the peer proceeds to a competing state 124. If the voting token transmitted when the peer left voting state 120 beats the received voting message, the competing state 124 is exited, and listening state 122 is returned to. If the received voting message trumps the transmitted voting message, the peer has lost the voting procedure, and enters a state where it runs as a peer 126. Every time that the peer enters the listening state 122, it initializes a timer. This timer allows the peer that wins all voting competitions, to determine that no other voting messages are being received. When the timer expires, the peer leaves the listening state and begins to run as a prime 128. When running as a prime, the peer transmits an assert prime message to all other peers that it has received votes from. This allows the peer to be recognized as the prime for the network. In response to the receipt of an assert prime message, a vanilla peer will transmit a peer update message to the prime so that a peer list can be built. In another embodiment, the prime can, at various intervals issue a peer update request message requesting that all peers in the network reply with a peer update message, so that an up to date peer listing can be maintained. When the prime receives a voting message from a new peer, it does not leave the running as prime state 128, but will transmits the assert prime message to that peer. When a node is in the running as a peer state 126 the receipt of an assert prime message does not change the state, nor does the receipt of either a peer update or voting message. To exit either the running as a peer 126 or running as a prime 128 states, a reset message must be received. The reset message can be generated by any peer in the network, or by the prime, allowing the prime to gracefully shut down without leaving the network primeless. From either state 128 or state 126, the receipt of a reset message sends the node back to the voting state 120, for re-election of a prime. In the prime state 128, in response to the receipt of a vote message, an AssertPrime message is sent, and optionally a heavily weighted competition may be entered.

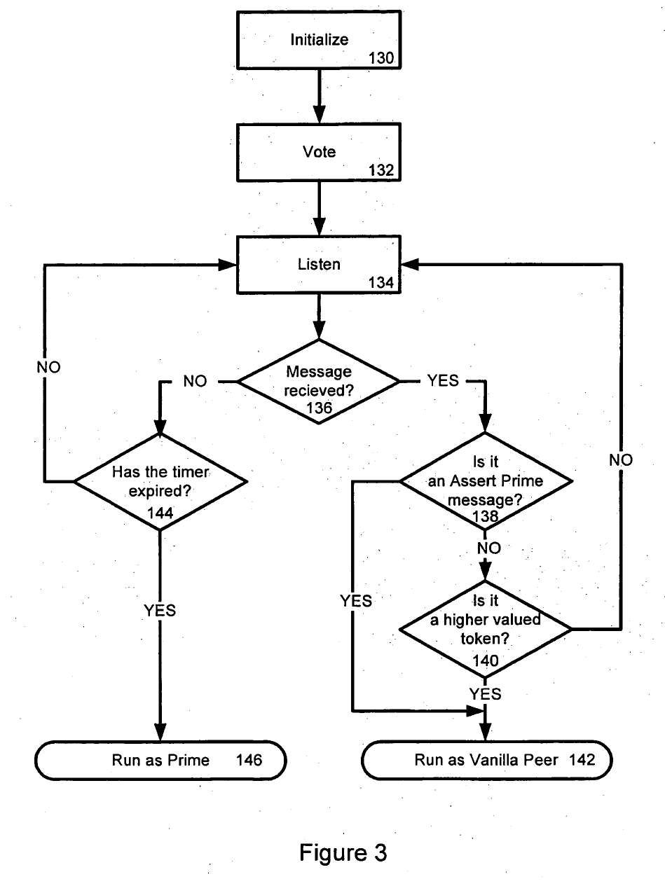

From the perspective of a node intializing and joining the network, the flowchart of FIG. 3 illustrates a method of determining whether or not the node will run as a vanilla peer or as a prime. In step 130, the node initializes as described above. A voting token is generated and transmitted in step 132. In step 134 the peer listens for a response to the transmitted voting token. If a message is received in step 136 it is examined in step 138 to determine if it is an assert prime message. If the received message is not an assert prime message, the node determines if the message contains a higher valued voting token in step 140. If there is a higher valued voting token, as determined in step 140, the node runs as a vanilla peer 142. If the message doesn't include a higher valued voting token, the system returns to listening at step 134. If, in step 138 it is determined that the message is an assert prime message, the network already has a prime, and the node can proceed to run as a vanilla peer. In an alternate embodiment, the receipt of an assert prime message can result in a competition to determine if the existing prime should remain the prime. In this embodiment, after step 138, new voting tokens are exchanged between the node and prime, and the process continues to step 140.

If in step 136, no message is received, the timer is examined in step 144. If the timer has not expired, the node continues to step 134 and listens for another response. If the timer has expired, as determined by step 144, the peer determines that it is prime and runs as prime in step 146. At this point, the peer is the prime peer and issues an assert prime message to all nodes in the network. The peers in the network respond to the assert prime message by providing peer update information from which a complete peer list, or a peer map is generated. At this point a “complete” message can be transmitted from the prime to all peers in the network to indicate that the discovery operation is complete and that a valid peer map is available.

After P′ has been selected, it can appoint various VP's in the network to serve as controllers for the various services (and their backups). P′ preferably selects appointees bottom up in the Peer Map. Selection in a bottom-up fashion from the peer map is presently preferred as it is likely that worker peers will be inlisted from the list in a top-down manner, thus the bottom-up selection method will minimize the intersection wherever possible.

Preferably, all peers must know every service controller. Thus, any peer wishing to participate in (or use) a given service can access the service controller. Services are therefore carefully selected as they may increase per peer state information and messaging. In one embodiment, the prime maintains a list of all service controllers, allowing any VP to contact the prime to determine the peer that is providing a particular service.

If a service controller go down, either one of its backup's or an application master will eventually discover the loss and inform the Prime Peer. The Prime can then select a new VP to fill the role and redistribute the service, assignment information.

The service assignment can be done by maintaining an active connection to each service controller candidate. The Candidate can accept the appointment or reject it based on implementation specific criteria. If the appointment is accepted, the Prime broadcasts the appointment to the rest of the network. Otherwise a new peer is selected for the appointment.

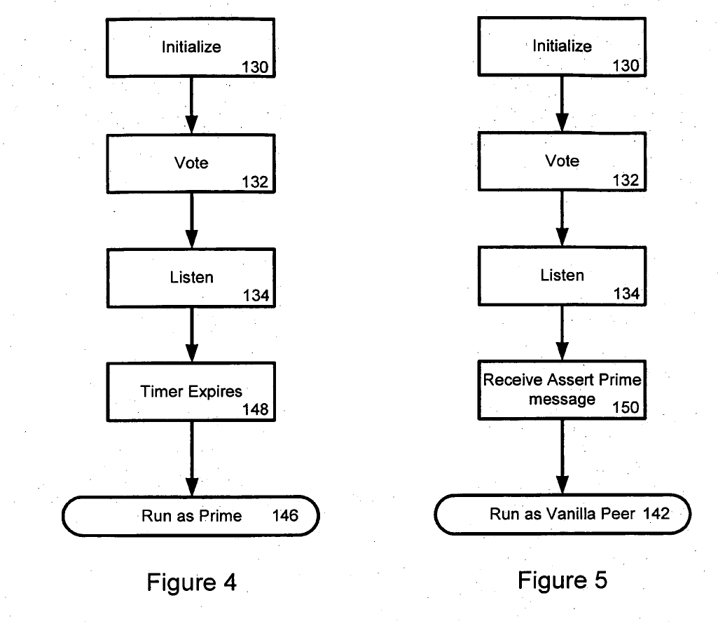

When the first node in the network is initialized, its process can be described with reference to the flowchart of FIG. 3, or as shown in the simplified flow chart of FIG. 4. The node initializes in step 130, proceeds to vote in step 132 and the listens for a response to the vote in step 134. The timer expires in step 148, corresponding to the appropriate decisions in step 136 and 144, and the node declares itself prime. At this point the network has only one node.

When another node enters the network, it's process can be described with reference to the flowchart of FIG. 3, or as shown in the simplified flow chart of FIG. 5. After initializing in step 130, voting in step 132 and listening in step 134, as described above, the node receives an assert prime message in step 150. The receipt of the assert prime message in step 150 corresponds to the appropriate decisions in steps 136 and 138. The node then proceeds to step 142 where it runs as a vanilla peer.

From the perspective of the prime, when a new VP is initialized, the Prime receives a vote message from the newly arriving VP. Because P′ has already been selected, the new node receives a notification (the AssertPrime message) that a Prime exists and its vote is of no consequence.

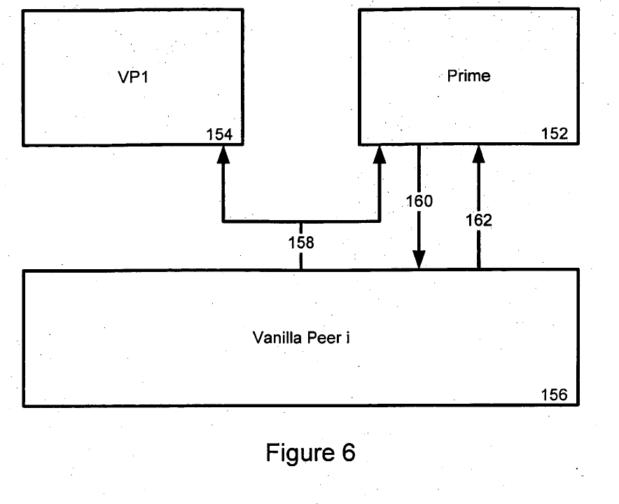

FIG. 6 illustrates a data flow for the event of a new peer joining an existing network. The network is shown as having prime 152 and a first vanilla peer, VP1 154. A new node Vanilla Peer i 156, joins the network and transmits a voting token 158. VP1 154 already knows that it is not the prime, and thus, disregards the voting token 158. Prime 152 responds to the voting token 158 by unicasting an assert prime message 160 to Vanilla Peer i 156. In response to the assert prime message 160, Vanilla Peer i 156 sends peer update information to prime 152 in message 162. Message 162 is preferably only sent to prime 152 to reduce network traffic. If VP1 154 receives a message that contains the information in message 162, that message preferably contains either new information from the Prime 152 or availability updates from worker peers.

It is preferable that each element in the p2p network be both robust and capable of error recovery. To that end, PSD preferably attempts to manage the fluid nature of nodes in a network while minimizing recoverability overhead and messaging.

PSD preferably provides accommodation for at least the following three situations where: two peers with equally high voting numbers assert primeship simultaneously; the prime in a network goes down and new elections are required; and where VP nodes are lost.

In the simultaneous prime assertion scenario two nodes simultaneously arrive on an otherwise empty network. This can also occur as a result of a reset message being broadcast or multicast to all nodes in the network. In one embodiment, the prime is selected between two equally ranked nodes on the basis of a property that must be unique, such as an IP address or a MAC address. In another embodiment, each node transmits as part of its voting token, a secondary vote. This secondary vote is ignored unless a collision of equal votes is received. The statistical probability of two collisions is considered to be sufficiently small that it will not happen if the prime voting is based on random seeds.

In the situation where the Prime node is lost, any new application master, which is by default at least a VP, attempting to run on the network will attempt to connect to the node it thinks is Prime. This connection will typically be made to obtain a peer map. If the prime has failed, the VP will determine that the prime in unavailable, and can either make use of a backup prime that has been previously designated and provided to all VP's, or the VP can send out a multicast RESET message. The RESET message causes all peers in the network to change back to the VOTING state, and elections ensue to obtain a new Prime, as described with reference to the earlier figures.

If a worker VP in the network goes down, it will not be detected until such time that a master application attempts to employ that node to do work. The failure to obtain a connection to the node can be reported to the prime. The Prime can then update the Global Peer Map. This information can be provided to any application masters in the system, either directly from the VP's or the prime can compile the list and provide it to each application master.

One skilled in the art will appreciate that there are a number of solutions for sending multicast messages across a wide area network, such as the internet. These solutions provide for simplified peer discovery outside of a single subnet. Multicast message forwarding may be performed by routers in the network and would be configured by the administrator of the p2p network environment. Multiple subnets typically require that each (subnet) has its own discovery prime (P′). All discoveries of other peers, for the P′ peer map, are isolated to the local subnet. All discovery multicast messages are within the local link multicast address range (224.0.0.1-224.0.0.255, 224.0.0.252-224.0.0.255).

If any of the masters on a particular subnet requires more peers than that available on its local subnet, a multicast message can be sent, using an inter-subnet multicast address (224.0.1.178-224.0.1.255), to all P′ on all other subnet in the local enterprise. Upon receiving the multicast message, the P′ would forward its local subnet peer map of available peers. This scenario allows for a plurality of p2p networks, each with its own prime to interact through messaging between primes.

If the master is successful in contacting the remote peer, and subsequently assigns it work, the peer can send an inter-subnet multicast message that it is busy doing work and that no attempt should be made until such time as it has completed its work and become available once again. Notification of availability would, again, be sent through inter-subnet multicast.

With the above described network, a peer-to-peer distributed computing architecture can be built. Because any peer in the network can obtain a listing of the other peers, any node in the network can submit a job. When a node wishes to submit a job to a number of peers, it contacts the prime and requests a peer map. The peer is typically provided with a listing of peers on its subnet to assist in reducing network traffic. If the job requires more peers than are presently available, either due to the peers being used for other jobs or due to the network being small, the submitting node can requests a map of nodes on other subnets. The reply to this request preferably includes a map of where the other peers can be found. The submitting node can then add the peers in the other subnets to the job, and contacts the remote peer. Communications across the subnets are preferably done using unicast transmissions. Once, a peer has been contacted and provided a job slice, it is considered part of the logical grid used for a single job.

If the situation arises that a peer on a different subnet cannot be reached, the master, or job submitting node, will preferably not send a multicast message to other masters on other subnets to inform them of a possible downed node. It would, however, preferably inform other master on its local subnet. The reason for not informing the masters on other subnets is that there are too many single points of failure between the master and the remote peer, and the peer could be unreachable to the master, but still active. As a result, informing masters outside of the original subnet may not be accurate. Therefore, to reduce the inter-subnet traffic, other masters are preferably not notified. Any discovery of it having gone down will be made by the other masters themselves in due course.

If a subnet, containing work peers, goes down, the subnet will be treated just as if a single peer had gone down. Therefore, all recovery procedure will be identical to the above discussion of a peer on another subnet going down.

It is preferable for a distributed p2p network used for grid or cluster computing to provide features such as load balancing. Load balancing may be provided at a higher layer in the protocol stack such as the Peer Map data structure, which maintains information such as Processor Type (Intel x86, Sparc, PPC, etc), Processor Speed (in MHz), Processor Count (for SMP support). Disc Speed (for I/O intensive jobs), Memory Size, and Memory Access Speed. Such information can be stored to allow querying by applications. These metrics are preferably collected when the VP starts and advertised via the PEERUPDATE message sent at startup time.

It is preferable that all aspects of PSD be hidden from an application programmer behind programming constructs allowing access to the collective computing resources of the network.

As discussed above, a grid can span a number of subnets. Similarly, a number of grids can co-exist on the same subnet. During the peer discovery process, peers make use of broadcast and multicast transmissions that are directed to specified ports. If there are a number of a grids on the same subnet, each node will receive traffic for the other grids during the discovery process. Additionally, when a reset message is sent to the nodes in a grid, it will be received by all the nodes in the subnet. To allow for the management of multiple grids on a single subnet, each grid is preferably assigned a grid identifier. The grid identifier can be combined with a shared secret, such as a password. When a node is configured to have a grid identifier and password, it can then include the grid identifier and information associated with the shared secret. When a node receives grid traffic, the node can compare the grid identifier and the shared secret information to the information it has been configured with. This use of grid identifier and shared secret allows a node to differentiate between traffic intended for its grid and traffic intended for other grids. One skilled in the art will appreciate that the use of a shared secret affords a degree of security to these transmissions, and can be used in conjunction with a common encryption or digital signature technology. Thus, a node can digitally sigh network messages so that they can be verified as originating from a node in a given grid. If encryption is used, then a transmitting node can be assured that only nodes in the same grid can determine the content of the message. Other applications of this functionality will be apparent to those skilled in the art.

One skilled in the art will appreciate that nodes of the network described above, can be implemented using standard computing hardware programmed according to the methods of the present invention. Such systems would typically have an input for receiving messages from other nodes, an output for transmitting messages to other nodes, and a state machine for generating messages for transmission and acting upon the received messages as described above.

The above-described embodiments of the present invention are intended to be examples only. Alterations, modifications and variations may be effected to the particular embodiments by those of skill in the art without departing from the scope of the invention, which is defined solely by the claims appended hereto.

1. A peer discovery method for determining a prime in a peer-to-peer network having at least one system, the method comprising:
transmitting a voting message including a voting token;
initializing a timer;
listening on a predetermined port for voting tokens transmitted by another system in the network; and
entering a prime mode upon expiry of the timer if no superior voting token is received.

2. The method of claim 1 further including the step of entering a vanilla peer mode when a superior voting token is received.

3. The method of claim 1 wherein the step of transmitting a voting message includes transmitting a voting token containing a voting number.

4. The method of claim 3 wherein the step of entering a prime mode includes determining that no received voting token has a higher voting number.

5. The method of claim 1 wherein the step of transmitting includes multicasting the voting token to all nodes on a subnet.

6. The method of claim 1 wherein the step of entering a prime mode includes transmitting an assertion of prime status to all nodes from whom a voting token is received.

7. The method of claim 1 wherein the step of entering a prime mode includes creating a list of all nodes from whom a voting token is received.

8. The method of claim 1 further including the step of entering a vanilla peer mode upon receipt of an assertion of prime status from another node.

9. The method of claim 1 wherein the step of listening includes listening for tokens associated with a grid identifier associated with the node.

10. The method of claim 1 further including the step of requesting an update from all peers from whom a voting token has been received upon entering the prime mode.
